(19) United States
(12) Patent Application Publication
(10) Pub. No.: US 2017/0299924 A1
(43) Pub. Date: Oct. 19, 2017

(54) LIQUID CRSYTAL DISPLAY DEVICE

(71) Applicant: Samsung Display Co., Ltd., Yongin-si (KR)

(72) Inventors: Taekyung YIM, Seoul (KR); Suwan WOO, Osan-si, Gyeonggi-do (KR); Jangil KIM, Asan-si, Chungcheongnam-do (KR); Keunwoo PARK, Incheon (KR); Jisun KIM, Seoul (KR)

(21) Appl. No.: 15/424,002

(22) Filed: Feb. 3, 2017

(30) Foreign Application Priority Data
Apr. 19, 2016 (KR) 10-2016-0047304

(51) Int. Cl. G02F 1/1337; G02F 1/1343; G02F 1/1333; G02F 1/1335

(52) U.S. Cl. CPC G02F 1/133707; G02F 1/133528; G02F 1/134309; G02F 1/13439; G02F 1/133345; G02F 2001/133742; G02F 2201/121; G02F 2201/123; G02F 2001/133531

(57) ABSTRACT

A liquid crystal display device includes a display substrate including a pixel electrode in a plurality of pixel areas; an opposing substrate opposing the display substrate; a liquid crystal layer between the display substrate and the opposing substrate; and a polarizer in at least one of the display substrate and the opposing substrate. The pixel electrode includes a first slit extending along an edge of the pixel electrode; and a second slit having substantially a quadrangular shape and having a long side which forms an angle ranging from about 0 degree to about 90 degrees with respect to a polarization axis of the polarizer.

### CROSS-REFERENCE TO RELATED APPLICATION

This application claims priority to Korean Patent Application No. 10-2016-0047304, filed on Apr. 19, 2016, and all the benefits accruing therefrom under 35 U.S.C. §119, the content of which in their entirety is herein incorporated by reference.

### BACKGROUND

### 1. Field

Exemplary embodiments of the inventive concept relate to a liquid crystal display (LCD) device, and more particularly, to a display substrate having improved display quality and an LCD device including the display substrate.

### 2. Description of the Related Art

Display devices are classified into a liquid crystal display (“LCD”) device, an organic light emitting diode (“OLED”) display device, a plasma display panel (“PDP”) device, an electrophoretic display (“EPD”) device, and the like, based on a light emitting scheme thereof.

An LCD device includes two substrates including electrodes formed thereon, respectively, and a liquid crystal layer between the two substrate. Upon applying voltage to the two electrodes, liquid crystal molecules of the liquid crystal layer are rearranged such that an amount of transmitted light is controlled in the LCD device. The LCD device includes an alignment layer which may align liquid crystal molecules to uniformly control the liquid crystal layer.

Among types of the LCD device, an LCD device in a vertically aligned mode, in which liquid crystal molecules are aligned so that a major axis thereof is perpendicular to the substrate in the absence of an electric field, has a relatively great contrast ratio and may provide a wide viewing angle.

In recent times, a technology is being employed to improve viewing angle properties whereby a pixel electrode is divided into multi-domains and liquid crystal molecules are aligned in different directions for each domain upon applying voltage. The plurality of domains may be formed using a cross-shaped stem portion and branch portions diagonally extending from the cross-shaped stem portion in different directions.

However, texture may appear at an edge portion of each of the branch portions due to shear stress arising from a process of patterning the branch portions.

It is to be understood that this background of the technology section is intended to provide useful background for understanding the technology and as such disclosed herein, the technology background section may include ideas, concepts or recognitions that were not part of what was known or appreciated by those skilled in the pertinent art prior to a corresponding effective filing date of subject matter disclosed herein.

### SUMMARY

Exemplary embodiments of the inventive concept are directed to a liquid crystal display (LCD) device capable of preventing texture appearing at an edge portion of each domain.

According to an exemplary embodiment of the inventive concept, a liquid crystal display device includes a display substrate including a pixel electrode disposed in a pixel area; an opposing substrate opposing the display substrate; a liquid crystal layer disposed between the display substrate and the opposing substrate; and a polarizer disposed on at least one of the display substrate and the opposing substrate. The pixel electrode includes a first slit extending along an edge of the pixel electrode; and a second slit having substantially a quadrangular shape and having a long side which extends parallel to or perpendicular to a polarization axis of the polarizer. The second slit may not overlap a center line which bisects the pixel electrode into two equal portions.

The first slit may have disconnections at boundaries between adjacent domains.

The first slit may have a width ranging from about 2 μm to about 5 μm.

A width of the long side of the second slit may be in a range of about 8 μm to about 10 μm, and a width of a short side of the second slit may be in a range of about 2 μm to about 5 μm.

The second slit may include a vertical slit having a long side which is perpendicular to the polarization axis; and a horizontal slit having a long side which is parallel to the polarization axis.

The vertical slit and the horizontal slit may be connected to each other.

The second slit may extend from one of domains into an adjacent one of the domains.

The pixel electrode may have a bump disposed in a center of the pixel electrode.

The bump may have a shape, in a plan view, selected from the group consisting of: a quadrangular shape, a circular shape, an elliptical shape, and a lozenge shape.

The bump may have a width ranging from about 2 μm to about 5 μm.

The liquid crystal display device may further include an insulating layer below the pixel electrode. The insulating layer may have a convex portion or a concave portion which has substantially a same shape, in a plan view, as that of the bump.

The pixel electrode may have a bump at boundaries between adjacent domains.

The bump may have a cross-shape in a plan view.

The bump may have a width ranging from about 2 μm to about 5 μm.

The liquid crystal display device may further include an insulating layer below the pixel electrode. The insulating layer may have a convex portion or a concave portion which has substantially a same shape, in a plan view, as that of the bump.

The liquid crystal display device may further include a common electrode on the opposing substrate. A slit may be absent in the common electrode.

According to an exemplary embodiment of the inventive concept, a liquid crystal display device includes a display substrate including a pixel electrode disposed in a pixel area; an opposing substrate opposing the display substrate; a liquid crystal layer disposed between the display substrate and the opposing substrate; and a polarizer disposed on at least one of the display substrate and the opposing substrate. The pixel electrode includes a first slit extending along an edge of the pixel electrode to define a plurality of domains, and the first slit includes an outer slit disposed at an outer portion of the pixel electrode; and at least one inner slit spaced apart from the outer slit and disposed inside of the outer slit.

Each of the outer slit and the inner slit may have disconnections at boundaries between adjacent domains.

Each of the outer slit and the inner slit may have a width ranging from about 2 μm to about 5 μm.

A width of the outer slit may be larger than a width of the inner slit.

The outer slit and the inner slit may be spaced apart from each other at a distance ranging from about 2 μm to about 5 μm.

The liquid crystal display device may further include a plurality of second slits having substantially a quadrangular shape and having a long side which forms an angle ranging from about 0 degree to about 90 degrees with respect to a polarization axis of the polarizer.

Distances between adjacent second slits may decrease as distances from a center of the pixel electrode to the plurality of second slits increase.

The liquid crystal display device may further include a common electrode on the opposing substrate. A slit may be absent in the common electrode.

According to an exemplary embodiment of the inventive concept, a liquid crystal display device includes a substrate, a pixel electrode disposed on the substrate, an opposing substrate opposing the display substrate, a liquid crystal layer disposed between the display substrate and the opposing substrate, and a polarizer disposed on at least one of the display substrate and the opposing substrate. The pixel electrode includes a first slit extending along an edge of the pixel electrode, and a plurality of second slits, the plurality of second slits having substantially a quadrangular shape and having a long side extending in a first direction which is parallel to or perpendicular to a polarization axis of the polarizer. The plurality of second slits do not overlap a center line which bisects the pixel electrode into two equal portions.

At least one of the plurality of second slits disposed closest to a center of the pixel electrode may extend different direction from other plurality of second slits.

The at least one of the plurality of second slits disposed closest to a center of the pixel electrode may extend perpendicular to the other plurality of second slits.

The pixel electrode may have a bump disposed in a center of the pixel electrode.

The pixel electrode may have a bump extending along boundaries between adjacent domains.

The foregoing is illustrative only and is not intended to in any way limit the scope of the inventive concept. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and aspects of the present disclosure of inventive concept will be more clearly understood from the following detailed description taken in conjunction with the accompanying drawings, in which:

FIG. 1 is a schematic plan view illustrating a pixel in a first exemplary embodiment of a liquid crystal display (LCD) device;

FIG. 2 is a cross-sectional view taken along line I-I′ of FIG. 1;

FIG. 3 is a plan view illustrating a pixel electrode of FIG. 1;

FIGS. 4, 5, 6, 7, 8, 9, 10, 11, 12, and 13 are plan views illustrating second, third, fourth, fifth, sixth, seventh, eighth, ninth, tenth, and eleventh exemplary embodiments of pixel electrodes;

FIG. 14 is a plan view illustrating a twelfth exemplary embodiment of a pixel electrode;

FIG. 15 is a cross-sectional view taken along line II-II′ of FIG. 14;

FIG. 16 is a plan view illustrating a thirteenth exemplary embodiment of a pixel electrode; and

FIG. 17 is a cross-sectional view taken along line III-III′ of FIG. 16.

### DETAILED DESCRIPTION

Exemplary embodiments will now be described more fully hereinafter with reference to the accompanying drawings. Although the inventive concept can be modified in various manners and have several embodiments, exemplary embodiments are illustrated in the accompanying drawings and will be mainly described in the specification. However, the scope of the inventive concept is not limited to the exemplary embodiments and should be construed as including all the changes, equivalents, and substitutions included in the spirit and scope of the inventive concept.

In the drawings, thicknesses of a plurality of layers and areas are illustrated in an enlarged manner for clarity and ease of description thereof. When a layer, area, or plate is referred to as being “on” another layer, area, or plate, it may be directly on the other layer, area, or plate, or intervening layers, areas, or plates may be present therebetween. Conversely, when a layer, area, or plate is referred to as being “directly on” another layer, area, or plate, intervening layers, areas, or plates may be absent therebetween. Further when a layer, area, or plate is referred to as being “below” another layer, area, or plate, it may be directly below the other layer, area, or plate, or intervening layers, areas, or plates may be present therebetween. Conversely, when a layer, area, or plate is referred to as being “directly below” another layer, area, or plate, intervening layers, areas, or plates may be absent therebetween.

The spatially relative terms “below”, “beneath”, “less”, “above”, “upper”, and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device shown in the drawing is turned over, the device positioned “below” or “beneath” another device may be placed “above” another device. Accordingly, the illustrative term “below” may include both the lower and upper positions. The device may also be oriented in the other direction, and thus the spatially relative terms may be interpreted differently depending on the orientations.

Throughout the specification, when an element is referred to as being “connected” to another element, the element is “directly connected” to the other element, or “electrically connected” to the other element with one or more intervening elements interposed therebetween. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” can be termed likewise without departing from the teachings herein.

Unless otherwise defined, all terms used herein (including technical and scientific terms) have the same meaning as commonly understood by those skilled in the art to which this inventive concept pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

Some of the parts which are not associated with the description may not be provided in order to specifically describe embodiments of the present inventive concept, and like reference numerals refer to like elements throughout the specification.

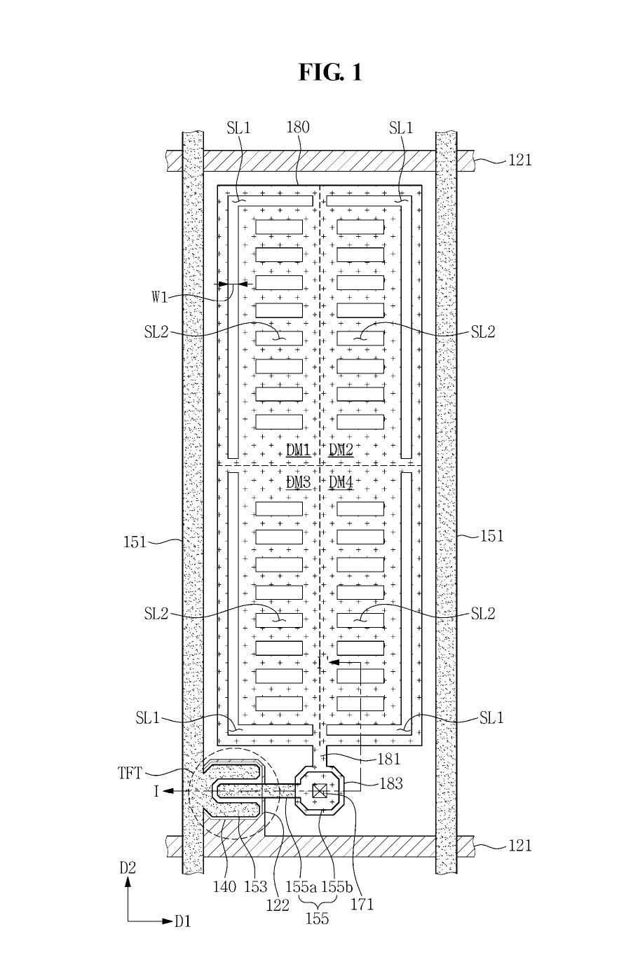

Hereinafter, a first exemplary embodiment will be described with reference to FIGS. 1, 2, and 3.

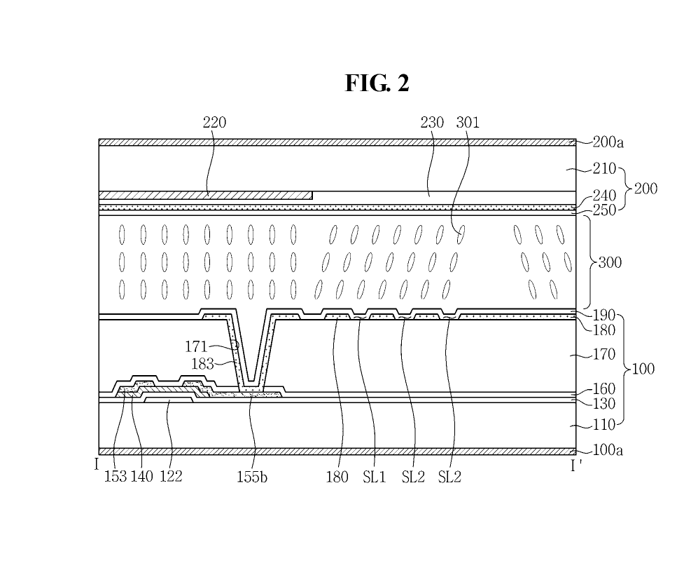

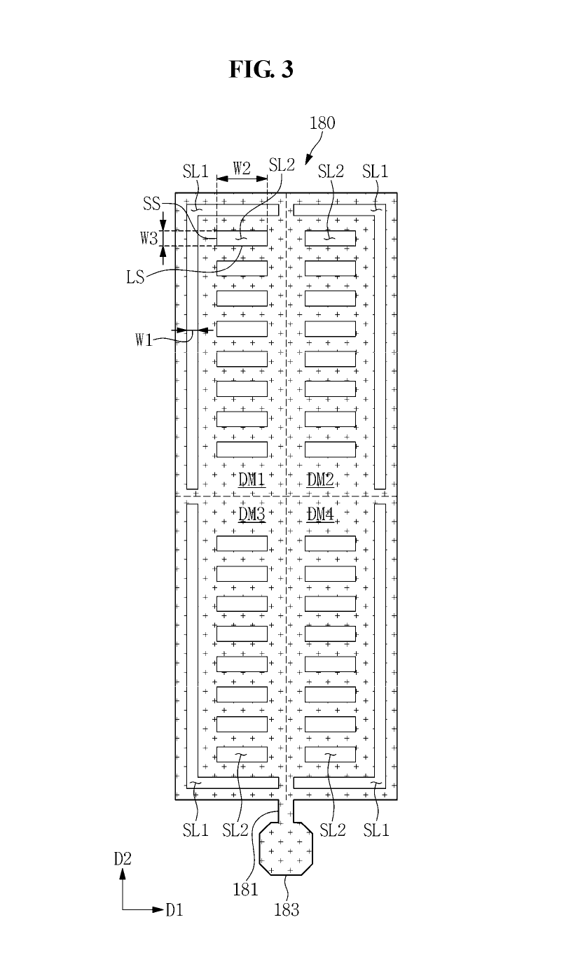

FIG. 1 is a schematic plan view illustrating a pixel in a first exemplary embodiment of a liquid crystal display (LCD) device, FIG. 2 is a cross-sectional view taken along line I-I′ of FIG. 1, and FIG. 3 is a plan view illustrating a pixel electrode of FIG. 1. An exemplary embodiment of an LCD device includes a plurality of pixels, but FIG. 1 illustrates one of the pixels and descriptions of other pixels and a pixel area will be omitted.

Referring to FIGS. 1 and 2, an exemplary embodiment of an LCD device includes a display substrate 100, an opposing substrate 200 opposing the display substrate 100, a liquid crystal layer 300 between the display substrate 100 and the opposing substrate 200, a first polarizer 100a included in the display substrate 100, and a second polarizer 200a included in the opposing substrate 200. It is illustrated in FIGS. 1 and 2 that in an exemplary embodiment of an LCD device, the first and second polarizers 100a and 200a are on the display substrate 100 and the opposing substrate 200, respectively, but exemplary embodiments are not limited thereto. The first and second polarizers 100a and 200a may be provided within the display substrate 100 and the opposing substrate 200 as in-cell polarizers. Further, an exemplary embodiment of an LCD device may further include a backlight unit (not illustrated) which emits light toward the display substrate 100.

The display substrate 100 may include a base substrate 110, a gate wiring 121 and 122, a first insulating layer 130, a semiconductor layer 140, a data wiring 151, 153, and 155, a second insulating layer 160, a third insulating layer 170, a pixel electrode 180, and a first alignment layer 190, for example.

The base substrate 110 may be an insulating substrate, such as a plastic substrate, which has light transmitting characteristics and flexibility. However, the first exemplary embodiment is not limited thereto, and the base substrate 110 may include a hard substrate such as a glass substrate.

The gate wiring 121 and 122 is disposed on the base substrate 110.

The gate wiring 121 and 122 includes a gate line 121 extending in a first direction D1 and a gate electrode 122 branching off from the gate line 121. The gate line 121 transmits a gate signal, and the gate electrode 122, along with a source electrode 153 and a drain electrode 155 to be described below, defines three terminals of a thin film transistor (TFT).

The gate wiring 121 and 122 may include or consist of aluminum (Al) or alloys thereof, silver (Ag) or alloys thereof, copper (Cu) or alloys thereof, molybdenum (Mo) or alloys thereof, chromium (Cr), tantalum (Ta), titanium (Ti), and/or the like.

In addition, the gate wiring 121 and 122 may have a multilayer structure including two or more conductive layers (not illustrated) having different physical properties. For example, a conductive layer of the multilayer structure may include or consist of a metal having low resistivity to reduce signal delay or voltage drop, e.g., an aluminum (Al)-based metal, a silver (Ag)-based metal, and a copper (Cu)-based metal, and another conductive layer of the multilayer structure may include a material that has an excellent contact property with indium tin oxide (ITO) and indium zinc oxide (IZO), such as a molybdenum-based metal, chromium, titanium, tantalum, and the like.

Examples of the multilayer structure may include a chromium lower layer and an aluminum upper layer, an aluminum lower layer and a molybdenum upper layer, and a titanium lower layer and a copper upper layer. However, exemplary embodiments are not limited thereto, and the gate wiring 121 and 122 may include various kinds of metals and conductors.

The first insulating layer 130 is disposed on the base substrate 110 on which the gate wiring 121 and 122 is disposed. The first insulating layer 130 may also be referred to as a gate insulating layer. The first insulating layer 130 may include silicon oxide (SiOₓ) or silicon nitride (SiNₓ). In addition, the first insulating layer 130 may have a double-layer structure or a multilayer structure including silicon oxide (SiOₓ) and silicon nitride (SiNₓ). In addition, the first insulating layer 130 may further include aluminum oxide, titanium oxide, tantalum oxide, or zirconium oxide.

The semiconductor layer 140 is disposed on the first insulating layer 130. The semiconductor layer 140 may include a semiconductor material such as amorphous silicon and crystalline silicon. In addition, the semiconductor layer 140 may include an oxide semiconductor such as IGZO, ITZO, ZnO, SnO₂, In₂O₃, Zn₂SnO₄, Ge₂O₃, and HfO₂ and may include a compound semiconductor such as GaAs, GaP, and InP.

In an exemplary embodiment, the semiconductor layer 140 is depicted as substantially overlapping the gate electrode 122. However, exemplary embodiments are not limited thereto, and the semiconductor layer 140 may substantially overlap the data wiring 151, 153, and 155 to be described hereinbelow.

The data wiring 151, 153, and 155 is disposed on the base substrate 110 on which the semiconductor layer 140 is disposed. The data wiring 151, 153, and 155 may include or consist of a same material as that forming the gate wiring 121 and 122.

The data wiring 151, 153, and 155 includes a data line 151 extending in a direction, e.g., a second direction D2, which intersects the gate line 121, a source electrode 153 branching off from the data line 151 to extend onto the semiconductor layer 140, and a drain electrode 155 spaced apart from the source electrode 153 and overlapping a portion of the semiconductor layer 140, for example.

An ohmic contact layer (not illustrated) may further be disposed between the semiconductor layer 140 and each of the source electrode 153 and the drain electrode 155 so as to improve electric characteristics.

The drain electrode 155 includes a first drain electrode 155a overlapping a portion of the semiconductor layer 140 and a second drain electrode 155b connected to the first drain electrode 155a and having a polygonal shape.

A channel through which electric charges move when the TFT is driven is defined in the semiconductor layer 140 between the source electrode 153 and the drain electrode 155.

The second insulating layer 160 is disposed on the base substrate 110 on which the data wiring 151, 153, and 155 is disposed. The second insulating layer 160 may also be referred to as an insulating interlayer. In an exemplary embodiment, the second insulating layer 160 may have a monolayer structure or a multilayer structure including, for example, silicon oxide, silicon nitride, a photosensitive organic material, or a low dielectric constant (low-k) insulating material, e.g., a-Si:C:O or a-Si:O:F.

The third insulating layer 170 is disposed on the second insulating layer 160. The third insulating layer 170 may have a monolayer structure or a multilayer structure including, for example, silicon oxide, silicon nitride, a photosensitive organic material, or a low dielectric constant (low-k) silicon-based insulating material.

However, exemplary embodiments are not limited thereto, and in a case where an LCD device has a color filter on array (COA) structure in which the color filter is disposed on the base substrate 110, a color filter may be provided in lieu of the third insulating layer 170 or a color filter may be provided between the second insulating layer 160 and the third insulating layer 170.

Referring to FIGS. 1, 2, and 3, the pixel electrode 180 is disposed on the third insulating layer 170. The pixel electrode 180 may be an electrode including a transparent conductor such as indium tin oxide (ITO) or indium zinc oxide (IZO).

The pixel electrode 180 may include a plurality of domains DM1, DM2, DM3, and DM4 arranged in a matrix form. However, exemplary embodiments are not limited thereto, and the pixel electrode 180 may be divided into a plurality of domains arranged in any suitable form.

The pixel electrode 180 may have a first slit SL1 and a second slit SL2 which define the plurality of domains DM1, DM2, DM3, and DM4.

The first slits SL1 may be formed along edges of the pixel electrode 180 with a predetermined distance from the edges and may be flexed at a right angle at corners of the pixel electrode 180. The predetermined distance may be about 1 μm to about 5 μm. The first slit SL1 may be disconnected at boundaries between adjacent domains DM1, DM2, DM3, and DM4. The first slit SL1 may have a width W1 ranging from about 2 μm to about 5 μm.

In an alternative exemplary embodiment, a width of the first slit SL1 may be increased from corner of the pixel electrode 180 toward the boundaries between the domains DM1, DM2, DM3, and DM4. In another alternative exemplary embodiment, the first slit SL1 may be disconnected at the corner of the pixel electrode 180.

In addition, the pixel electrode 180 may have substantially a quadrangular shape, and may have at least one second slit SL2 having a long side LS which forms an angle in a range of about 0 degree to about 90 degrees with respect to a polarization axis of the first and second polarizers 100a and 200a. The second slit may include a plurality of slits arranged in parallel with one another at a predetermined interval.

The second slit SL2 has the long side LS and a short side SS.

According to the first exemplary embodiment, the polarization axis of the first polarizer 100a and the polarization axis of the second polarizer 200a may be parallel to or perpendicular to the first direction D1 in a plan view. The polarization axis of the first polarizer 100a and the polarization axis of the second polarizer 200a may be parallel to each other or perpendicular to each other. Accordingly, the long side LS of the second slit SL2 may be parallel to or perpendicular to the first direction D1 in a plan view. In addition, the pixel electrode 180 may be defined with at least one second slit SL2 in each of the domains DM1, DM2, DM3, and DM4.

A width W2 of the long side LS of the second slit SL2 may be in a range of about 8 μm to about 10 μm, and a width W3 of the short side SS thereof may be in a range of about 2 μm to about 5 μm.

As such, the first exemplary embodiment of the pixel electrode 180 is defined with the second slit SL2 which is parallel to or perpendicular to the polarization axis of the first polarizer 100a and the second polarizer 200a such that texture which appears at an edge of the second slit SL2 may be significantly less recognized, and transmittance and visibility may be improved.

In addition, the pixel electrode 180 includes a connecting portion 181 which extends outwards from the pixel electrode 180 and a pixel electrode contacting portion 183 connected to the connecting portion 181 and having a polygonal shape. The pixel electrode contacting portion 183 is connected to the second drain electrode 155b through a contact hole 171.

Referring back to FIGS. 1 and 2, the first alignment layer 190 is disposed on the pixel electrode 180. In the absence of an electric field between the display substrate 100 and the opposing substrate 200, the first alignment layer 190 may align liquid crystal molecules 301 included in the liquid crystal layer 300 to be inclined with respect to the first alignment layer 190. The first alignment layer 190 may be a homeotropic alignment layer or a photoalignment layer including a photopolymerizable material. An LCD device including the photoalignment layer is referred to as being in a photoalignment mode.

In a case where the liquid crystal molecules 301 of the liquid crystal layer 300 are disposed on the first alignment layer 190, the liquid crystal molecules 301 may be pre-tilted to a central portion of the pixel electrode 180 due to the first slit SL1 and the second slit SL2 of the pixel electrode 180. The liquid crystal layer 300 may include polymer materials that are polymerized by a reactive monomer or a reactive mesogen.

In a case where reactive monomers included in the liquid crystal molecules 301 are polymerized by irradiating ultraviolet (UV) light thereto while applying an electric field during a process of manufacturing an LCD device, the liquid crystal layer 300 may be aligned to have different pre-tilt angles for each domain. An LCD device including such liquid crystal molecules 301 is referred to as a surface stabilized vertical alignment (SVA) mode. The LCD device in a SVA mode may display an image with a high response time.

The opposing substrate 200 may include an opposing base substrate 210, a light blocking member 220, an overcoat layer 230, and a common electrode 240. In an exemplary embodiment, the opposing substrate 200 may further include a second alignment layer 250.

The opposing base substrate 210 may be an insulating substrate, e.g., a plastic substrate, which has light transmitting characteristics and flexibility. However, the first exemplary embodiment is not limited thereto, and the opposing base substrate 210 may include a hard substrate such as a glass substrate.

The light blocking member 220 is disposed on the opposing base substrate 210. The light blocking member 220 may also be referred to as a black matrix, and may include a metal such as chromium oxide (CrOx) or an opaque organic-layer material.

The light blocking member 220 may have a plurality of apertures substantially similar to those of the pixel electrode 180 so that light emitted from the backlight unit (not illustrated) may be transmitted through the pixel electrode 180. In addition, the light blocking member 220 may be formed in portions corresponding to the TFT provided on the base substrate 110. However, exemplary embodiments are not limited thereto, and the light blocking member 220 may be disposed on the base substrate 110.

The overcoat layer 230 is disposed on the light blocking member 220 and the opposing base substrate 210. The overcoat layer 230 planarizes an uneven surface of a layer therebelow, e.g., the light blocking member 220, and efficiently suppresses or prevents diffusion of undesirable materials from the layer therebelow.

The common electrode 240 is disposed on the overcoat layer 230. An exemplary embodiment of the common electrode 240 may be a whole-plate electrode including a transparent conductor such as indium tin oxide (ITO) or indium zinc oxide (IZO).

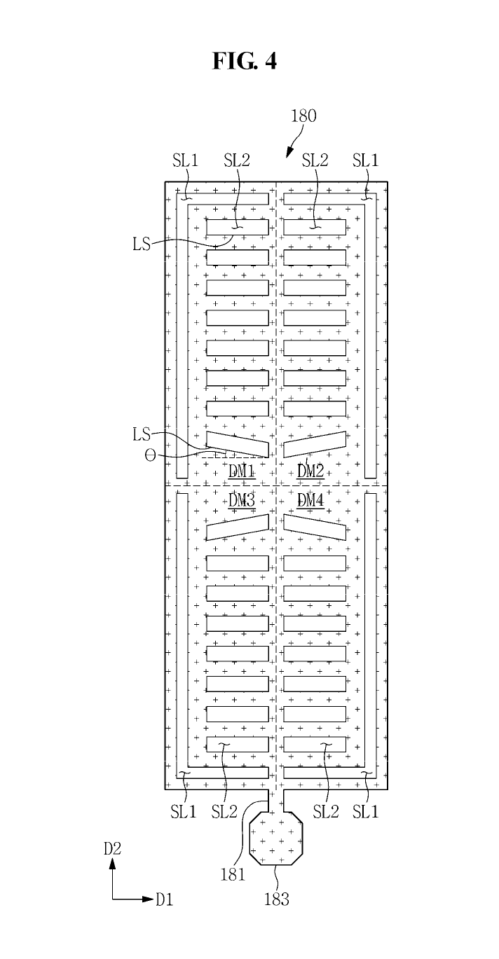

FIGS. 4, 5, 6, 7, 8, 9, 10, 11, 12, 13, and 14 are plan views illustrating second, third, fourth, fifth, sixth, seventh, eighth, ninth, tenth, eleventh, and twelfth exemplary embodiments of pixel electrodes. Repeated descriptions pertaining to the first exemplary embodiment will be omitted in the descriptions pertaining to the second, third, fourth, fifth, sixth, seventh, eighth, ninth, tenth, eleventh, and twelfth exemplary embodiments.

Referring to FIGS. 4, 5, and 6, the second, third, and fourth exemplary embodiments of the pixel electrode 180 have, so as to define a plurality of domains DM1, DM2, DM3, and DM4, a first slit SL1 extending along an edge of the pixel electrode 180 and at least one second slit S2 having substantially a quadrangular shape and having a long side LS which has an angle θ ranging from about 0 degree to about 90 degrees with respect to a first direction D1.

The second slits SL2 in each of the domains DM1, DM2, DM3, and DM4 may have different angles θ with respect to the first direction D1.

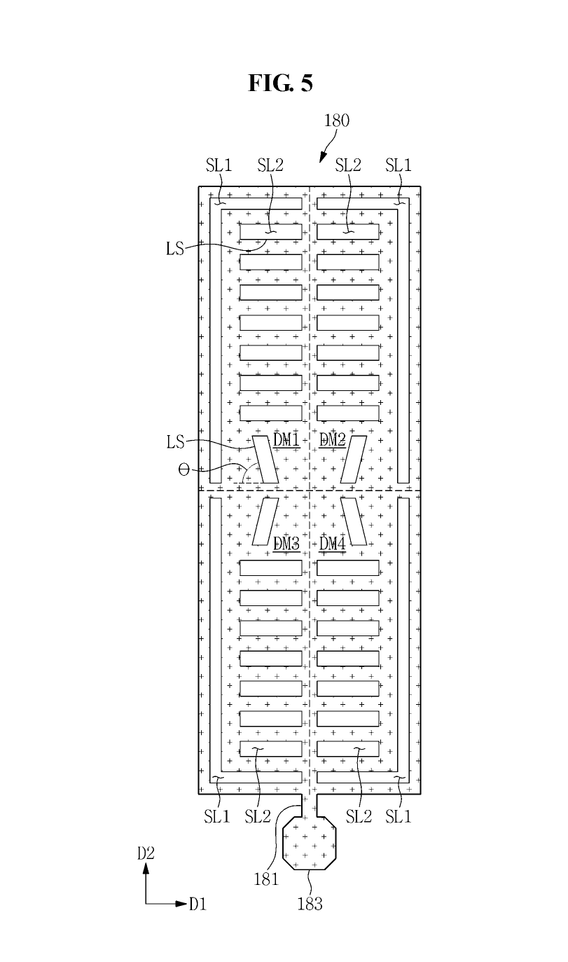

That is, as illustrated in FIGS. 4 and 5, the each of the domains DM1, DM2, DM3, and DM4may have a second slit SL2 having a long side LS which is parallel (0 degree) to the first direction D1 in a plan view and a second slit SL2 having a long side LS which has an angle ranging from about 0 degree to about 90 degrees with respect to the first direction D1.

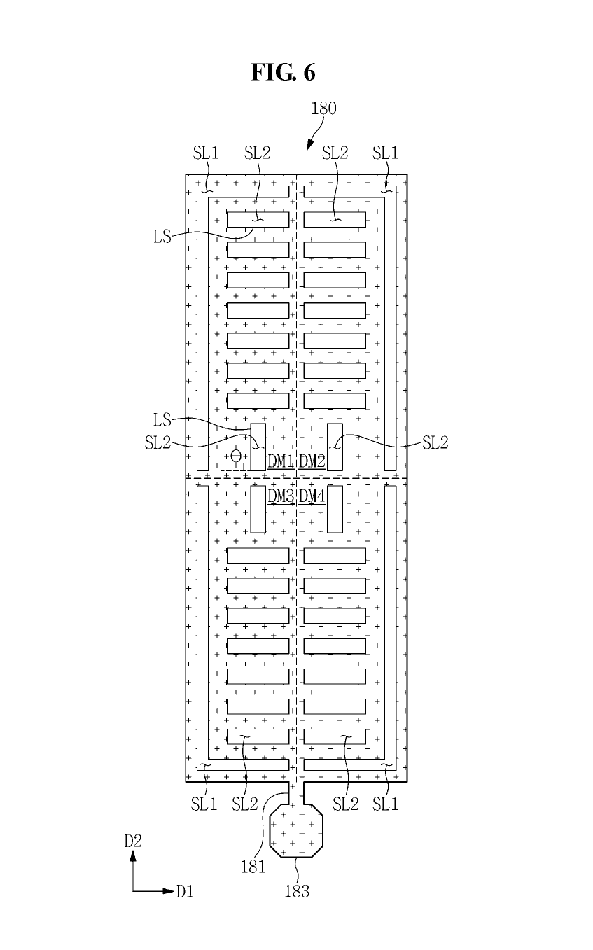

In addition, as illustrated in FIG. 6, the each of the domains DM1, DM2, DM3, and DM4may have a second slit SL2 having a long side LS which is parallel (0 degree) to the first direction D1 in a plan view and a second slit SL2 having a long side LS which is perpendicular (90 degrees) to the first direction D1 in a plan view.

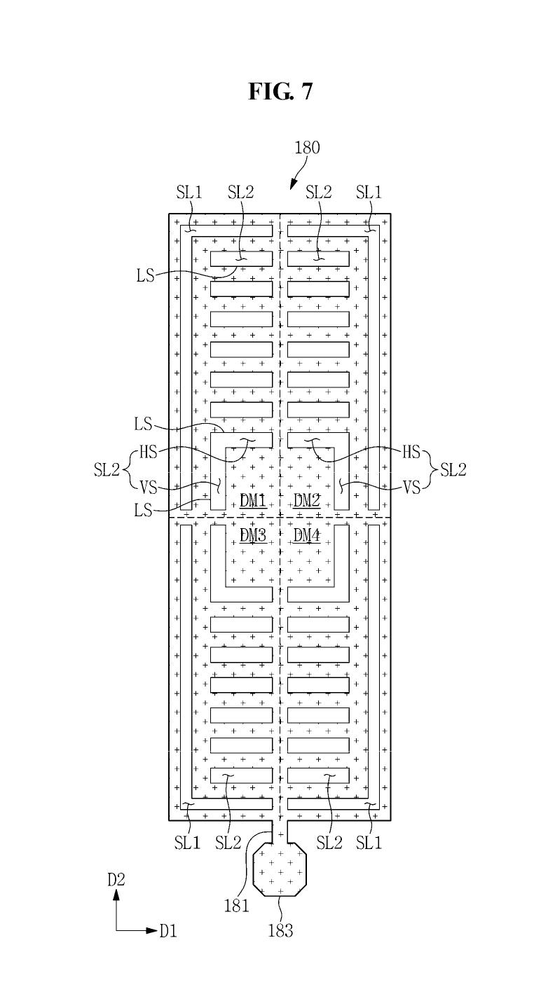

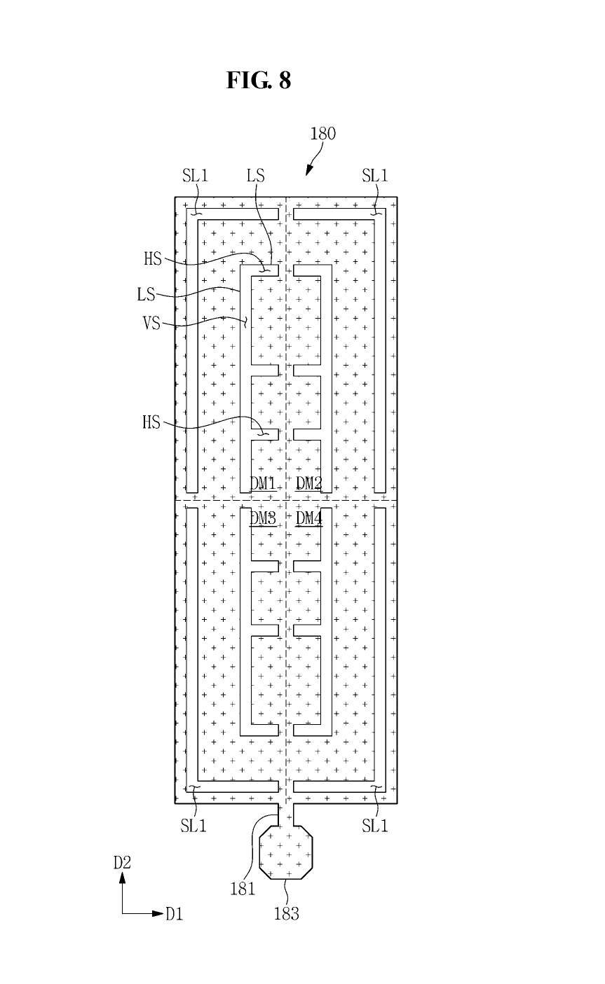

Referring to FIGS. 7 and 8, the fifth and sixth exemplary embodiments of the pixel electrode 180 have, so as to define a plurality of domains DM1, DM2, DM3, and DM4, a first slit SL1 extending along an edge of the pixel electrode 180 and at least one second slit SL2 having substantially a quadrangular shape and having a long side LS which has an angle ranging from about 0 degree to about 90 degrees with respect to the first direction D1.

The second slit SL2 includes a horizontal slit HS having a long side LS which is parallel (0 degree) to the first direction D1 and a vertical slit VS having a long side LS which is perpendicular (90 degrees) to the first direction D1. The vertical slit VS may be connected to the horizontal slit HS adjacent thereto (refer to FIG. 7) or may be connected to all of the horizontal slits HS included in each of the domains DM1, DM2, DM3, and DM4 (refer to FIG. 8). Referring to FIG. 7, the second slit SL2 may further include horizontal slits HS which is not connected to the vertical slit VS. The second slits SL2 having the horizontal slit HS connected to the vertical slit VS are disposed at a center of the pixel electrode 180 to surround the center of the pixel electrode 180.

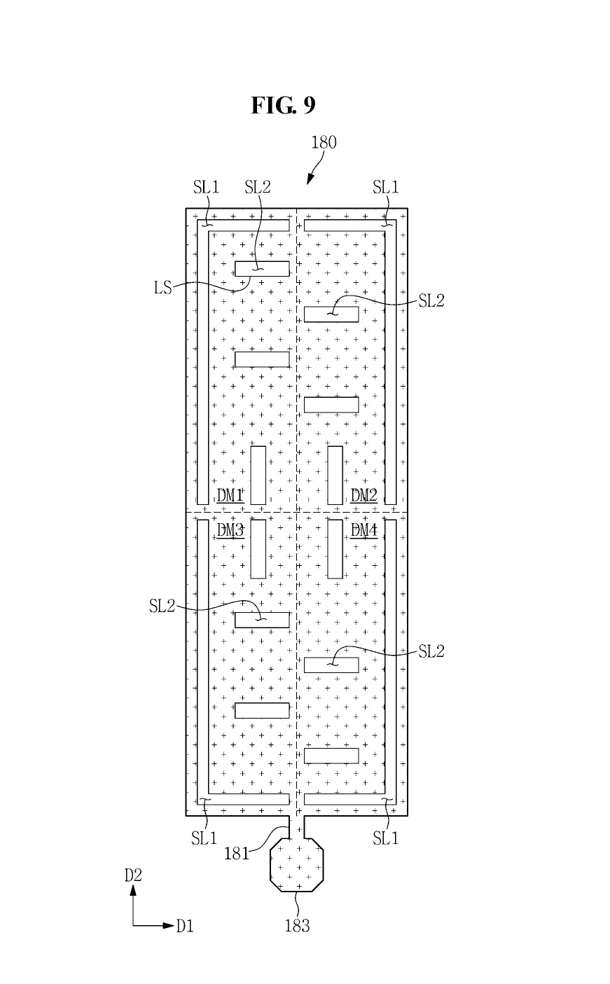

Referring to FIGS. 9, 10, and 11, the seventh, eighth, and ninth exemplary embodiments of the pixel electrode 180 have, so as to define a plurality of domains DM1, DM2, DM3, and DM4, a first slit SL1 extending along an edge of the pixel electrode 180 and at least one second slit SL2 having substantially a quadrangular shape and having a long side LS which has an angle ranging from about 0 degree to about 90 degrees with respect to the first direction D1.

Referring to FIG. 9, the seventh exemplary embodiment of the pixel electrode 180 may include second slits SL2 which forms a zigzag shape with respect to a boundary between domains (e.g., DM1 and DM2) that are adjacent to each other in the first direction D1. The second slits SL2 in each of a first domain DM1 and a second domain that is disposed adjacent to the first domain DM1 may have first slits extending parallel to the first direction D1 and a second slit extending perpendicular to the first direction. The first slit in the first domain DM1 and the second domain DM2 may be disposed not to extend along a line parallel to the first direction D1. The second slit extending perpendicular to the first direction D1 may be disposed closet to a center of the pixel electrode 180 than the first slit extending parallel to the first direction D1 and may be disposed at centers of the domains DM1, DM2, DM3, and DM4.

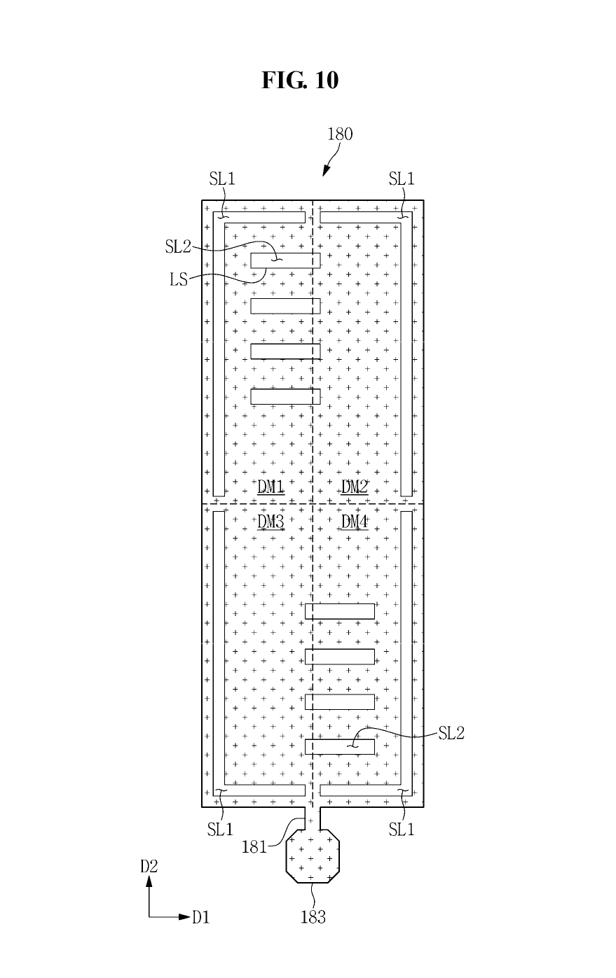

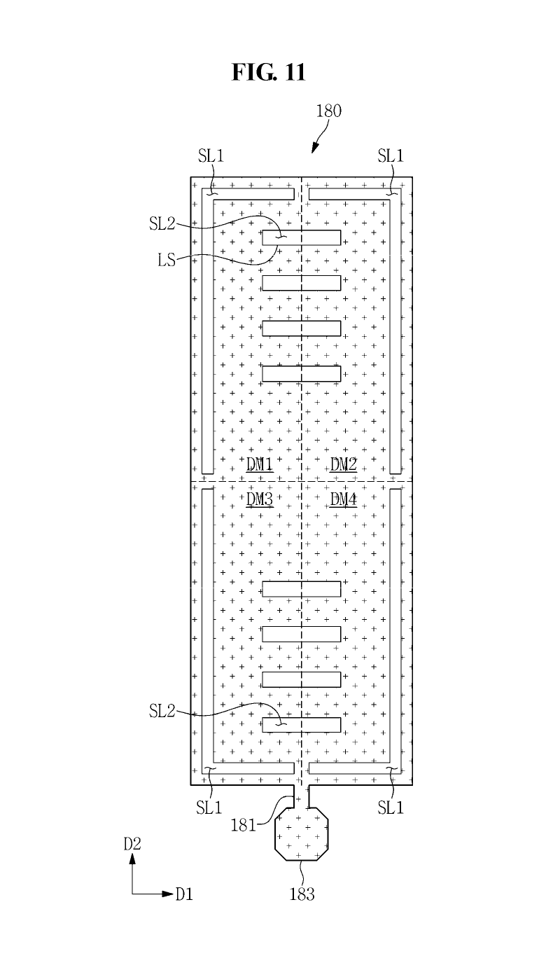

Referring to FIGS. 10 and 11, the eighth and ninth exemplary embodiments of the pixel electrode 180 may have second slits SL2 which extend from one of the domains (e.g., DM1) to another of the domains (e.g., DM2) that is adjacent to the one of the domains in the first direction D1. As illustrated in FIG. 10, the first domain DM1 and the second domain DM2 share the second slits SL2. The second slits extend in a direction parallel to the first direction D1. An area of each of the second slits SL2 in the first domain DM1 is wider than that in the second domain DM2. The third domain DM3 and the fourth domain DM4 share the second slits SL2. The second slits extend in a direction parallel to the first direction D1. An area of each of the second slits SL2 in the fourth domain DM4 is wider than that in the third domain DM3. In particular, as illustrated in FIG. 11, each of the second slits SL2 may has line symmetry with a boundary between the domains as a line of symmetry.

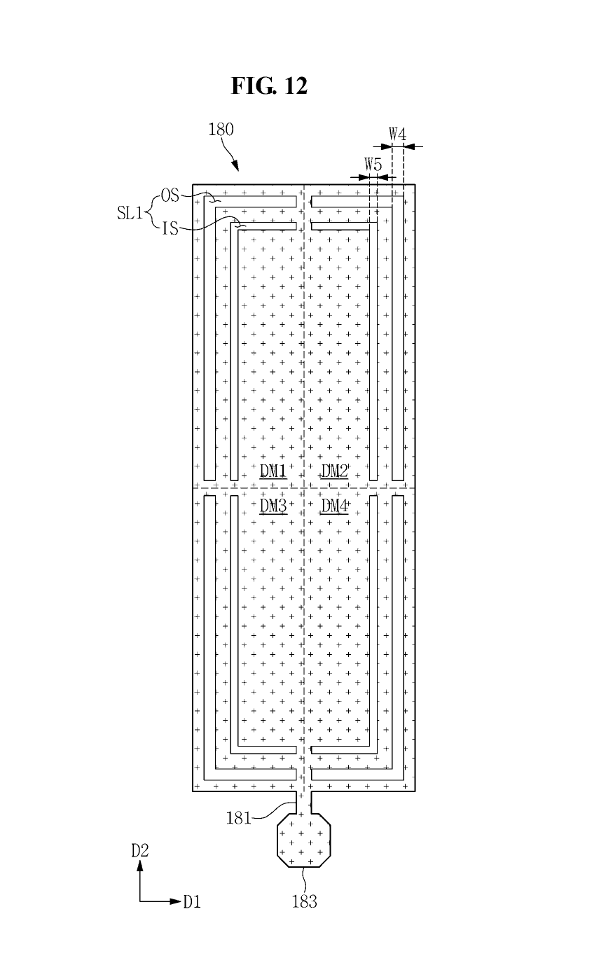

Referring to FIG. 12, an exemplary embodiment of the pixel electrode 180 may have a first slit SL1 extending along an edge of the pixel electrode 180 so as to define a plurality of domains DM1, DM2, DM3, and DM4. The first slit SL1 may include an outer slit OS disposed at an outermost portion of the pixel electrode 180 with a predetermined distance from edges of the pixel electrode 180 and at least one inner silt IS spaced apart from the outer slit OS and disposed inside of the outer slit OS.

Each of the outer slit OS and the inner slit IS may be disconnected at boundaries between adjacent domains DM1, DM2, DM3, and DM4, and the outer slit OS and the inner slit IS may have substantially a same shape.

The outer slit OS and the inner slit IS may each have a width ranging from about 2 μm to about 5 μm, and a width W4 of the outer slit OS may be larger than a width W5 of the inner slit IS. In a case where the inner slit IS includes a plurality of inner slits IS, the width of the inner slits IS may decrease as distances from the edges of the pixel electrode 180 to the inner slits IS increase.

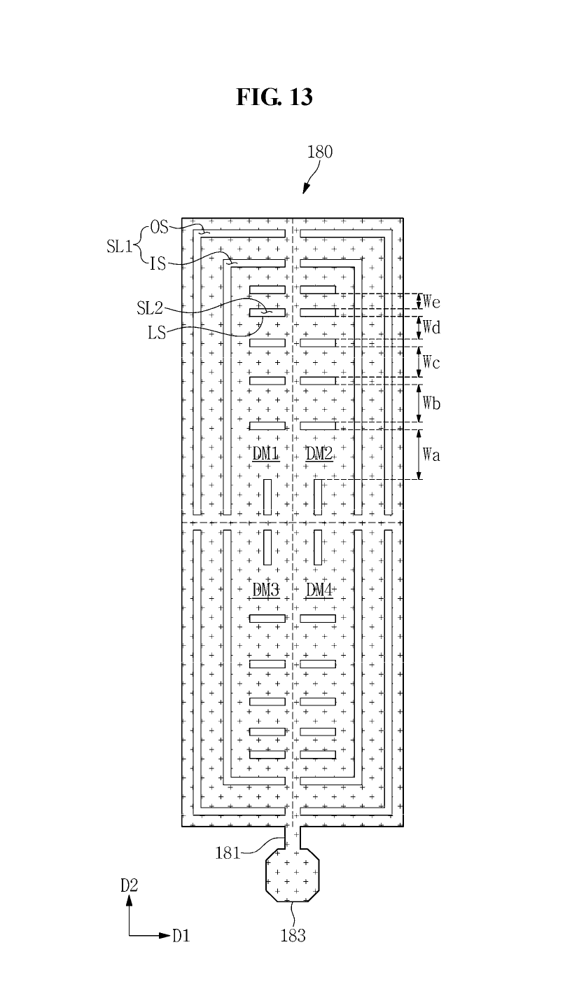

Referring to FIG. 13, an exemplary embodiment of the pixel electrode 180 has a first slit SL1 and a second slit SL2 so as to define a plurality of domains DM1, DM2, DM3, and DM4. The first slit SL1 may extend along edges of the pixel electrode 180 and the second slits S2 may have substantially a quadrangular shape and have a long side LS which has an angle ranging from about 0 degree to about 90 degrees with respect to the first direction D1.

The first slit SL1 may include an outer slit OS disposed at an outer portion of the pixel electrode 180 and at least one inner silt IS spaced apart from the outer slit OS and dispose inside of the outer slit OS.

In addition, respective distances Wa, Wb, Wc, Wd, and We among the second slits SL2 disposed in ones of the domains DM1, DM2, DM3, and DM4 may decrease as distances from a center of the pixel electrode 180 to the second slits SL2 increases. For example, Wa>Wb>Wc>Wd>We may be satisfied.

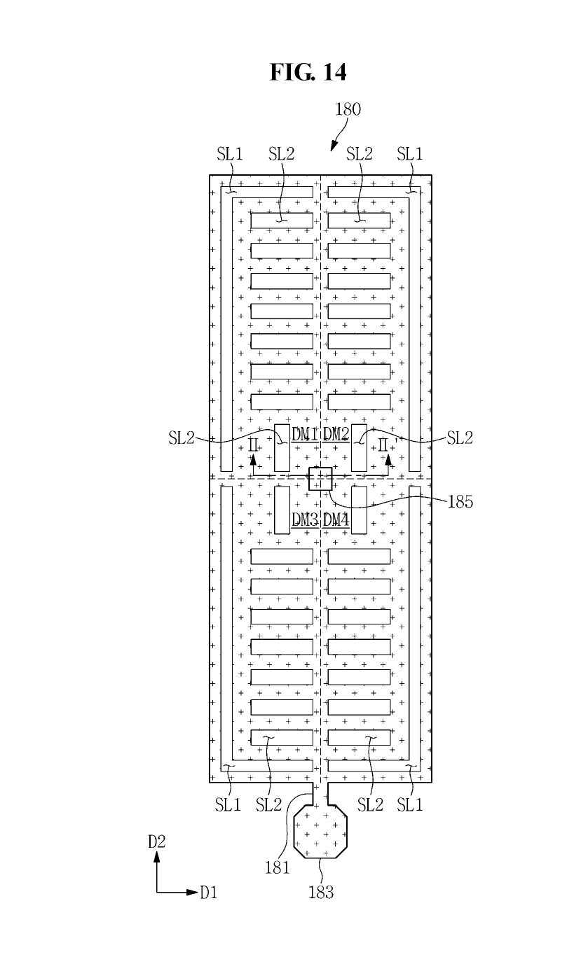

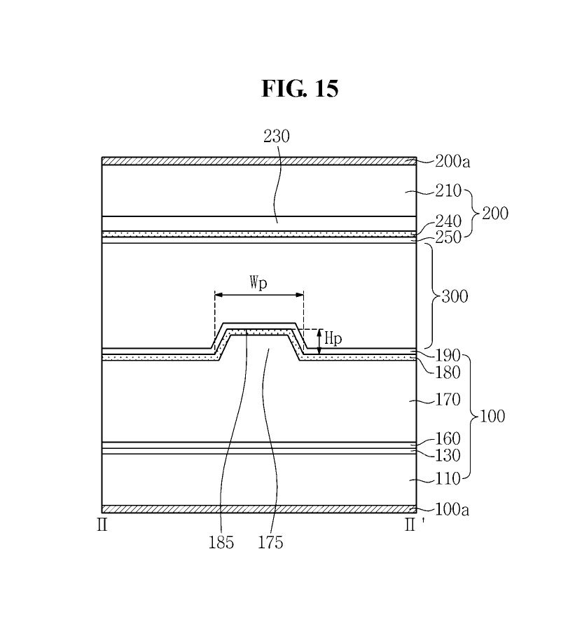

FIG. 14 is a plan view illustrating a twelfth exemplary embodiment of a pixel electrode, and FIG. 15 is a cross-sectional view taken along line II-II′ of FIG. 14. Repeated descriptions pertaining to the exemplary embodiment described hereinabove will be omitted in the descriptions pertaining to the twelfth exemplary embodiment.

Referring to FIGS. 14 and 15, the twelfth exemplary embodiment of the pixel electrode 180 has a first slit SL1 and a second slit SL2 so as to define a plurality of domains DM1, DM2, DM3, and DM4. The first slit SL1 may extend along an edge of the pixel electrode 180 and the second slit S2 may have substantially a quadrangular shape and have a long side LS which has an angle ranging from about 0 degree to about 90 degrees with respect to the first direction D1.

In addition, the pixel electrode 180 may have a bump 185 in a central portion thereof. The bump 185 may be a convex portion or a concave portion, and the twelfth exemplary embodiment of the pixel electrode 180 is described under the assumption that it has a convex portion in a central portion thereof. The bump 185 may be one selected from the group consisting of: a quadrangular shape, a circular shape, an elliptical shape, and a lozenge shape.

The bump 185 may have a height Hp ranging from about 0.1 μm to about 1.0 μm and a width Wp ranging from about 2 μm to about 15 μm.

The third insulating layer 170 may have a protrusion 175 at a portion corresponding to the bump 185. The protrusion 175 may have a shape protruding from the third insulating layer 170. The protrusion 175 may have substantially a same shape as that of the bump 185 in a plan view.

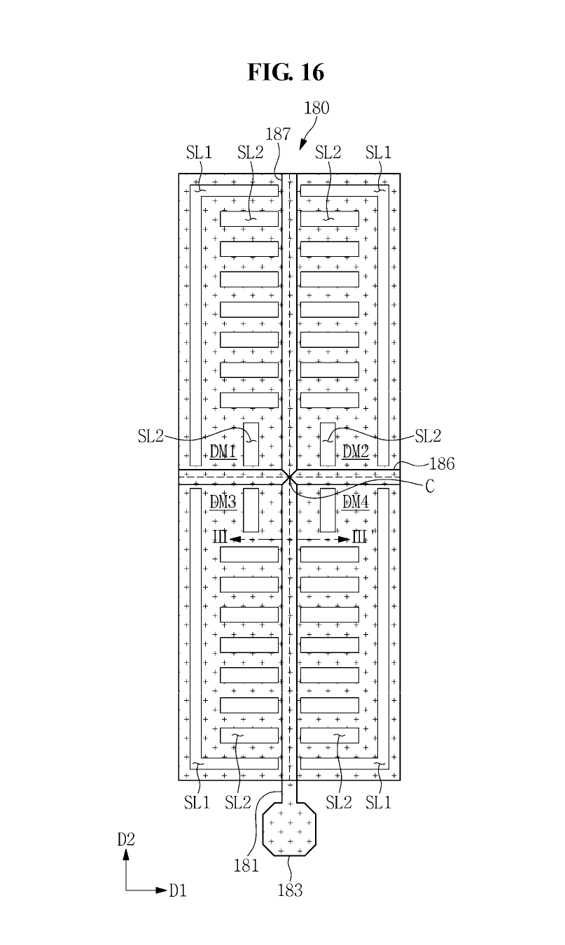

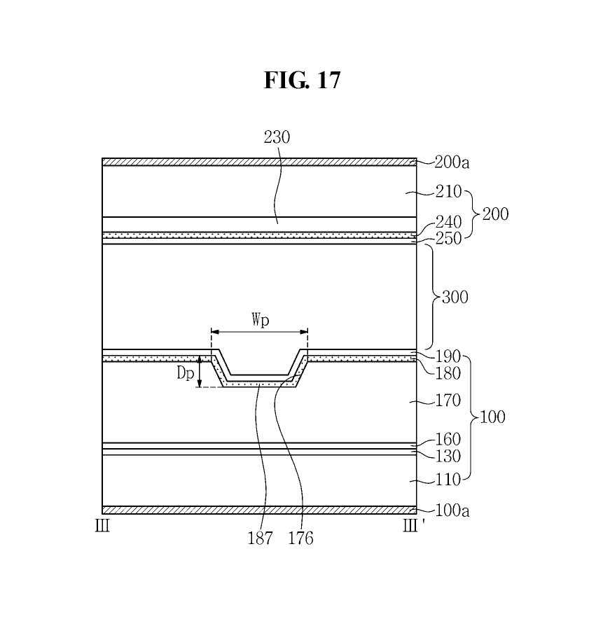

FIG. 16 is a plan view illustrating a thirteenth exemplary embodiment of a pixel electrode, and FIG. 17 is a cross-sectional view taken along line III-III′ of FIG. 16. Repeated descriptions pertaining to the exemplary embodiment described hereinabove will be omitted in the descriptions pertaining to the thirteenth exemplary embodiment.

Referring to FIGS. 16 and 17, the thirteenth exemplary embodiment of the pixel electrode 180 has a first slit SL1 and a second slit SL2 so as to define a plurality of domains DM1, DM2, DM3, and DM4. The first slit SL1 may extend along an edge of the pixel electrode 180 and the second slit S2 may have substantially a quadrangular shape and have a long side LS which has an angle ranging from about 0 degree to about 90 degrees with respect to the first direction D1.

In addition, the pixel electrode 180 may have a bump 186 and 187 at boundaries between adjacent domains DM1, DM2, DM3, and DM4. For example, the bump 186 and 187 may include a first bump 186 extending in a first direction D1 and a second bump 187 extending in a second direction D2 which intersects the first direction D1. The first bump 186 and the second bump 187 may be a convex portion or a concave portion, and the thirteenth exemplary embodiment of the first bump 186 and the second bump 187 will be described under the assumption that they have concave portions.

The first bump 186 and the second bump 187 may have a cross shape in a plan view. The first bump 186 and the second bump may be disposed at a center of the pixel electrode 180 to bisect the pixel electrode 180 into two equal portions, respectively. In an alternative exemplary embodiment, one of the first bump 186 and the second bump 187 may be omitted. An intersecting area C between the first bump 186 and the second bump 187 may have a shape, in a plan view, selected from the group consisting of: a quadrangular shape, a circular shape, an elliptical shape, and a lozenge shape.

The first bump 186 and the second bump 187 may each have a depth Dp ranging from about 0.1 μm to about 1.0 μm and a width Wp ranging from about 2 μm to about 15 μm.

The first bump 186 and the second bump 187 are depicted as having a same width Wp, but exemplary embodiments are not limited thereto. The widths Wp of the first bump 186 and the second bump 187 may gradually increase or decrease, as further away from the intersecting area C.

In addition, the first bump 186 and the second bump 187 may have different widths from each other. For example, the first bump 186 may have a larger width than that of the second bump 187.

The third insulating layer 170 may have a trench 176 at an area corresponding to the first bump 186 and the second bump 187. The trench 176 may have a shape of the third insulating layer 170 being dented. The trench 176 may have substantially a same shape as that of the first bump 186 and the second bump 187.

As set forth hereinabove, in one or more exemplary embodiments of an LCD device, a pattern which is perpendicular to or parallel to, or has a predetermined angle with respect to a polarization axis of a polarizer is formed on a pixel electrode, and thus texture, appearing at an edge of the pattern, may be significantly less recognized and transmittance and visibility may be improved.

From the foregoing, it will be appreciated that various embodiments in accordance with the present disclosure have been described herein for purposes of illustration, and that various modifications may be made without departing from the scope and spirit of the present teachings. Accordingly, the various embodiments disclosed herein are not intended to limit the true scope and spirit of the present teachings. Various features of the above described and other embodiments can be mixed and matched in any manner, to produce further embodiments consistent with the inventive concept.

What is claimed is:

1. A liquid crystal display device comprising:
a display substrate comprising a pixel electrode disposed in a pixel area;
an opposing substrate opposing the display substrate;
a liquid crystal layer disposed between the display substrate and the opposing substrate; and
a polarizer disposed on at least one of the display substrate and the opposing substrate,
wherein the pixel electrode including:
a first slit extending along an edge of the pixel electrode; and
a second slit having substantially a quadrangular shape and having a long side which forms an angle ranging from about 0 degree to about 90 degrees with respect to a polarization axis of the polarizer.

2. The liquid crystal display device as claimed in claim 1, wherein the first slit has disconnections at boundaries between adjacent domains.

3. The liquid crystal display device as claimed in claim 1, wherein the first slit has a width ranging from about 2 μm to about 5 μm.

4. The liquid crystal display device as claimed in claim 1, wherein a width of the long side of the second slit is in a range of about 8 μm to about 10 μm, and a width of a short side of the second slit is in a range of about 2 μm to about 5 μm.

5. The liquid crystal display device as claimed in claim 1, wherein the second slit comprises:
a vertical slit having a long side which is perpendicular to the polarization axis; and
a horizontal slit having a long side which is parallel to the polarization axis.

6. The liquid crystal display device as claimed in claim 5, wherein the vertical slit and the horizontal slit are connected to each other.

7. The liquid crystal display device as claimed in claim 1, wherein the second slit extends from one of domains into an adjacent one of the domains.

8. The liquid crystal display device as claimed in claim 1, wherein the pixel electrode has a bump disposed in a center of the pixel electrode.

9. The liquid crystal display device as claimed in claim 8, wherein the bump has a shape, in a plan view, selected from the group consisting of: a quadrangular shape, a circular shape, an elliptical shape, and a lozenge shape.

10. The liquid crystal display device as claimed in claim 9, wherein the bump has a width ranging from about 2 μm to about 5 μm.

11. The liquid crystal display device as claimed in claim 9, further comprising an insulating layer below the pixel electrode, wherein the insulating layer has a convex portion or a concave portion which has substantially a same shape, in a plan view, as that of the bump.

12. The liquid crystal display device as claimed in claim 1, wherein the pixel electrode has a bump at boundaries between adjacent domains.

13. The liquid crystal display device as claimed in claim 12, wherein the bump has a cross-shape in a plan view.

14. The liquid crystal display device as claimed in claim 13, wherein the bump has a width ranging from about 2 μm to about 5 μm.

15. The liquid crystal display device as claimed in claim 13, further comprising an insulating layer below the pixel electrode, wherein the insulating layer has a convex portion or a concave portion which has substantially a same shape, in a plan view, as that of the bump.

16. The liquid crystal display device as claimed in claim 1, further comprising a common electrode on the opposing substrate, wherein a slit is absent in the common electrode.

17. A liquid crystal display device comprising:
a display substrate comprising a pixel electrode disposed in a plurality of pixel areas;
an opposing substrate opposing the display substrate;
a liquid crystal layer disposed between the display substrate and the opposing substrate; and
a polarizer disposed on at least one of the display substrate and the opposing substrate,
wherein the pixel electrode includes a first slit extending along an edge of the pixel electrode to define a plurality of domains, and
the first slit comprises:
an outer slit disposed at an outer portion of the pixel electrode; and
at least one inner slit spaced apart from the outer slit and disposed inside of the outer slit.

18. The liquid crystal display device as claimed in claim 17, wherein each of the outer slit and the inner slit has disconnections at boundaries between adjacent domains.

19. The liquid crystal display device as claimed in claim 17, wherein each of the outer slit and the inner slit has a width ranging from about 2 μm to about 5 μm.

20. The liquid crystal display device as claimed in claim 19, wherein a width of the outer slit is larger than a width of the inner slit.

21. The liquid crystal display device as claimed in claim 17, wherein the outer slit and the inner slit are spaced apart from each other at a distance ranging from about 2 μm to about 5 μm.

22. The liquid crystal display device as claimed in claim 17, further include a plurality of second slits having substantially a quadrangular shape and having a long side which forms an angle ranging from about 0 degree to about 90 degrees with respect to a polarization axis of the polarizer.

23. The liquid crystal display device as claimed in claim 22, wherein distances between adjacent second slits decrease as distances from a center of the pixel electrode to the plurality of second slits increase.

24. The liquid crystal display device as claimed in claim 17, further comprising a common electrode on the opposing substrate, wherein a slit is absent in the common electrode.

25. A liquid crystal display device comprising:
a substrate;
a pixel electrode disposed on the substrate;
an opposing substrate opposing the display substrate;
a liquid crystal layer disposed between the display substrate and the opposing substrate; and
a polarizer disposed on at least one of the display substrate and the opposing substrate,
wherein the pixel electrode including:
a first slit extending along an edge of the pixel electrode; and
a plurality of second slits, the plurality of second slits having substantially a quadrangular shape and having a long side extending in a first direction which is parallel to or perpendicular to a polarization axis of the polarizer,
wherein the plurality of second slits do not overlap a center line which bisects the pixel electrode into two equal portions.

26. The liquid crystal display device as claimed in claim 25, wherein at least one of the plurality of second slits disposed closest to a center of the pixel electrode extends different direction from other plurality of second slits.

27. The liquid crystal display device as claimed in claim 26, wherein the at least one of the plurality of second slits disposed closest to a center of the pixel electrode extends perpendicular to the other plurality of second slits.

28. The liquid crystal display device as claimed in claim 27, wherein the pixel electrode has a bump disposed in a center of the pixel electrode.

29. The liquid crystal display device as claimed in claim 27, wherein the pixel electrode has a bump extending along boundaries between adjacent domains.
